(19) United States
(12) Patent Application Publication
(10) Pub. No.: US 2005/0190549 A1
(43) Pub. Date: Sep. 1, 2005

(54) Eye and face shield with attached lamp

(76) Inventors: Adam P. Donaldson, Greenville, SC (US); Mitchell Johnson, Hope Mills, NC (US)

Correspondence Address: Richard C. Litman;LITMAN LAW OFFICES, LTD., P.O. Box 15035, Arlington, VA, 22215, US

(21) Appl. No.: 10/787,753

(22) Filed: Feb. 27, 2004

(51) Int. Cl. F21V 21/084

(52) U.S. Cl. 362/106; 362/105

(57) ABSTRACT

An eye and face shield having an attached lamp. The shield is entirely transparent so that a wearer's normal field of vision is unrestricted. The shield is of a size to afford protection for the entire facial area. A battery-operated lamp is attached to the shield to illuminate work sites where visibility is poor. The shield and the lamp are pivotally fastened to a headband. The pivoting ability allows a user to quickly and easily move the shield from the face, if desired, without removing the entire device from the head. The headband can be adjusted to accommodate different head sizes.

### BACKGROUND OF THE INVENTION

1. Field of the Invention

The present invention generally relates to protective devices. More specifically, the present invention is drawn to a protective eye and face shield having an illuminating device attached thereto.

2. Description of the Related Art

Each year, many debilitating and painful injuries occur to the faces and eyes of industrial personnel because of the lack of proper protective gear. These accidents depress worker morale and cause the loss of millions of dollars due to downtime and medical costs. The industrial and insurance complexes are constantly seeking efficient protective gear so that workers may avoid the effects of such accidents. There are many devices in the related art designed to afford protection to the facial area of workers. However, the related art devices usually lack the size and versatility to insure utmost protection for the face and eye areas. For example U.S. Pat. No. 3,833,936 (LoGuidice), U.S. Pat. No. 4,332,004 (Slaughter) and U.S. Pat. No. 6,340,234 B1 (Brown, Jr.) show welders' masks with a protective viewing glass. The small viewing area would limit the wide-angle vision necessary to insure that the adjacent area is hazard free.

U.S. Pat. No. 5,667,291 (Caplin et al.) discloses a shield and illumination assembly for dental and medical applications. It is noted that the shield protects the eyes but offers no protection for the majority of the facial area.

U.S. Pat. No. 6,009,563 (Swanson et al.) is drawn to a safety helmet adapted for use in sailing. The helmet includes a safety shield for the face. However, the shield is not pivoted for easy movement from the face if desired.

U.S. Pat. No. 5,664,868 (Montalbano et al.) discloses a helmet having a face shield and two illumination sources. Neither the shield nor the illumination sources can be pivoted to a non-use position.

U.S. Pat. No. 5,564,128 (Richardson) describes a helmet having a electroluminescent strip thereon. The strip allows for visual identification of the wearer and does not illuminate the adjacent area.

U.S. Pat. No. 4,958,264 (Evendon) shows a pivoted face shield having a lamp attachment. The lamp cannot be pivoted with the shield.

U.S. Pat. No. 4,530,112 (Cecala et al.) describes a shield having a light source, which source emits a beam that remains oriented the same even if the shield is pivoted away from the face.

None of the above inventions and patents, taken either singly or in combination, is seen to disclose a face and eye shield having a lamp attachment as will subsequently be described and claimed in the instant invention.

### SUMMARY OF THE INVENTION

The present invention is drawn to an eye and face shield having an attached lamp. The shield is entirely transparent so that a wearer's normal field of vision is unrestricted. The shield is of a size to afford protection for the entire facial area. A battery-operated lamp is attached to the shield to illuminate work sites where visibility is poor. The shield and the lamp are pivotally fastened to a headband. The pivoting ability allows a user to quickly and easily move the shield from the face, if desired, without removing the entire device from the head. The headband can be adjusted to accommodate different head sizes.

Accordingly, the invention provides a protective shield that safeguards the entire facial area. The shield, lamp and band are fabricated from improved elements for the purposes described which elements are inexpensive, dependable and fully effective in accomplishing their intended purposes.

A clear understanding of the present invention will become readily apparent upon further review of the following specification and drawings.

### BRIEF DESCRIPTION OF THE DRAWINGS

FIG. 1 is an environmental, front view of an eye and face shield with attached lamp according to the present invention.

FIG. 2 is an environmental, side view of an eye and face shield with attached lamp according to the present invention.

FIG. 3 is an environmental, side view of an eye and face shield with attached lamp in a non-protective position according to the present invention.

FIG. 4 is a top view of an eye and face shield with attached lamp according to the present invention.

Similar reference characters denote corresponding features consistently throughout the attached drawings.

### DETAILED DESCRIPTION OF THE PREFERRED EMBODIMENT

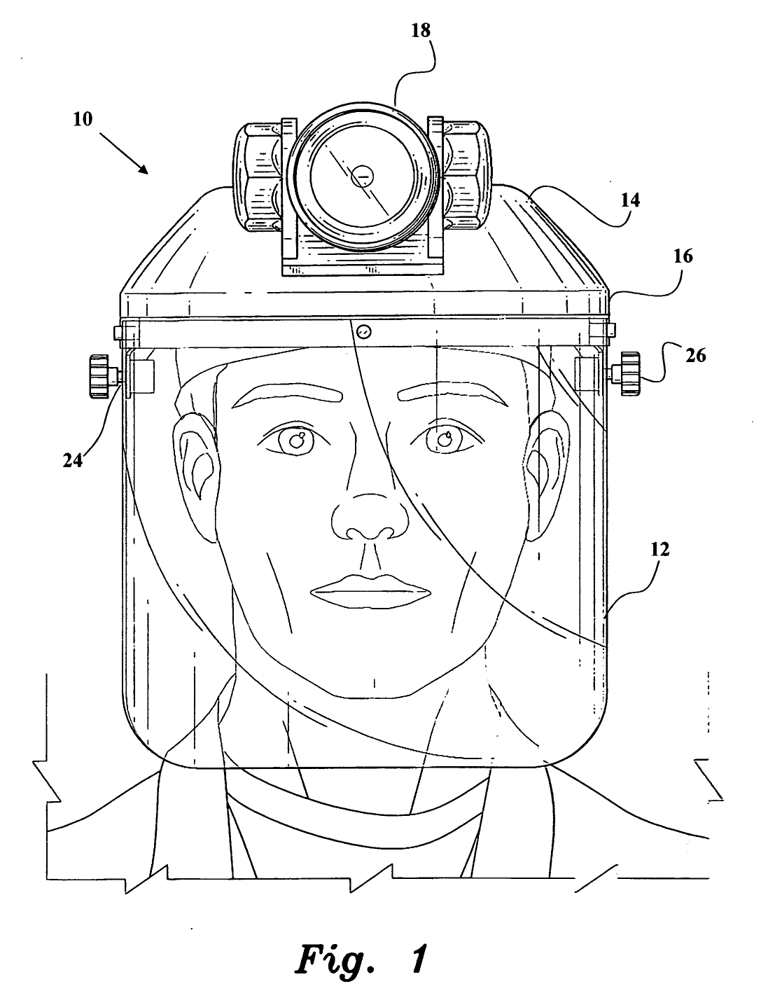

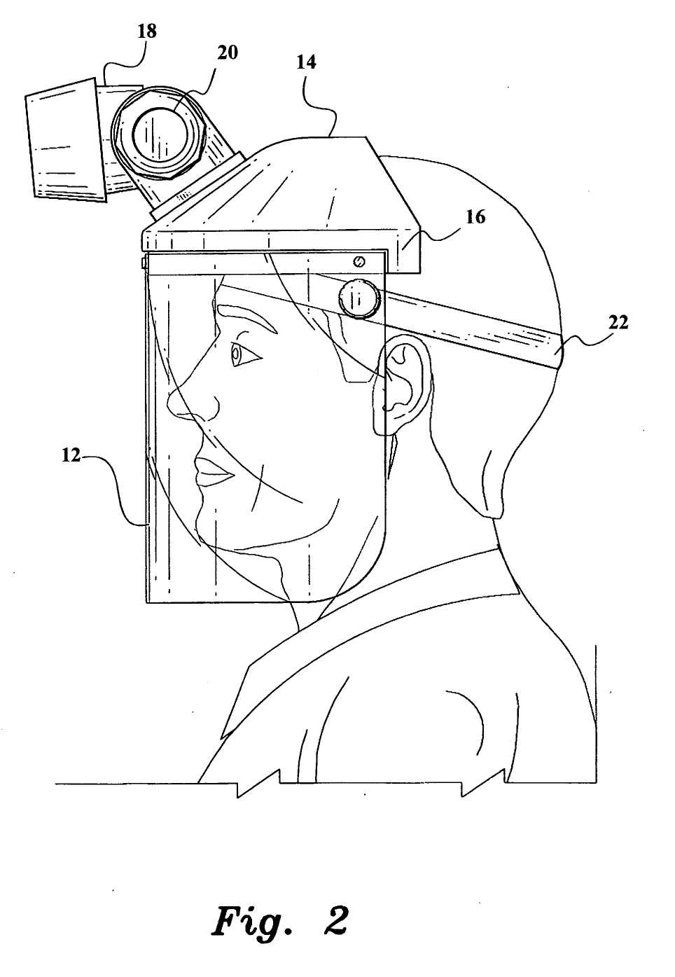

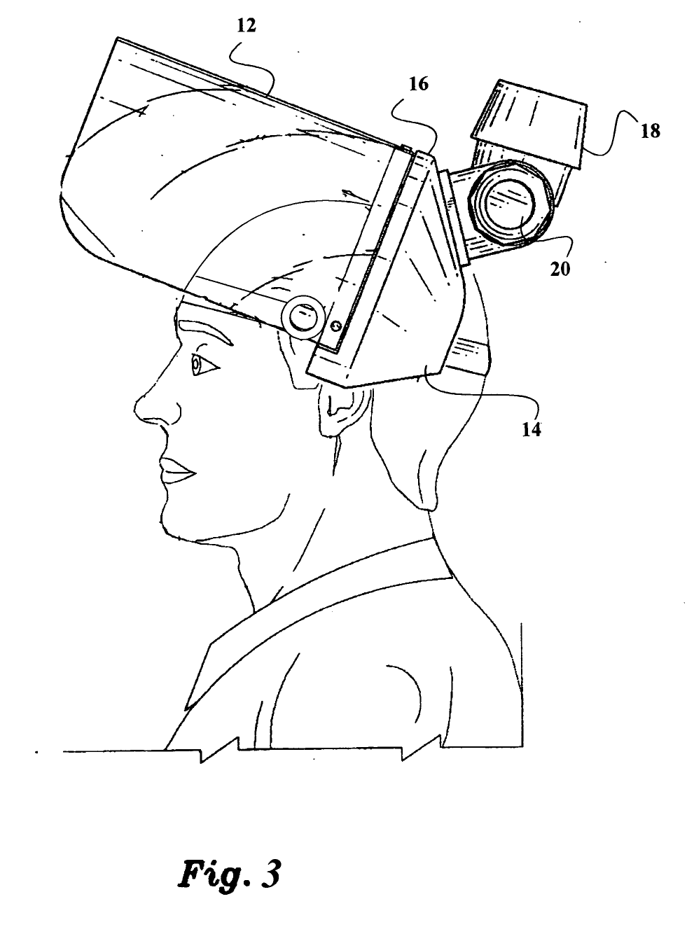

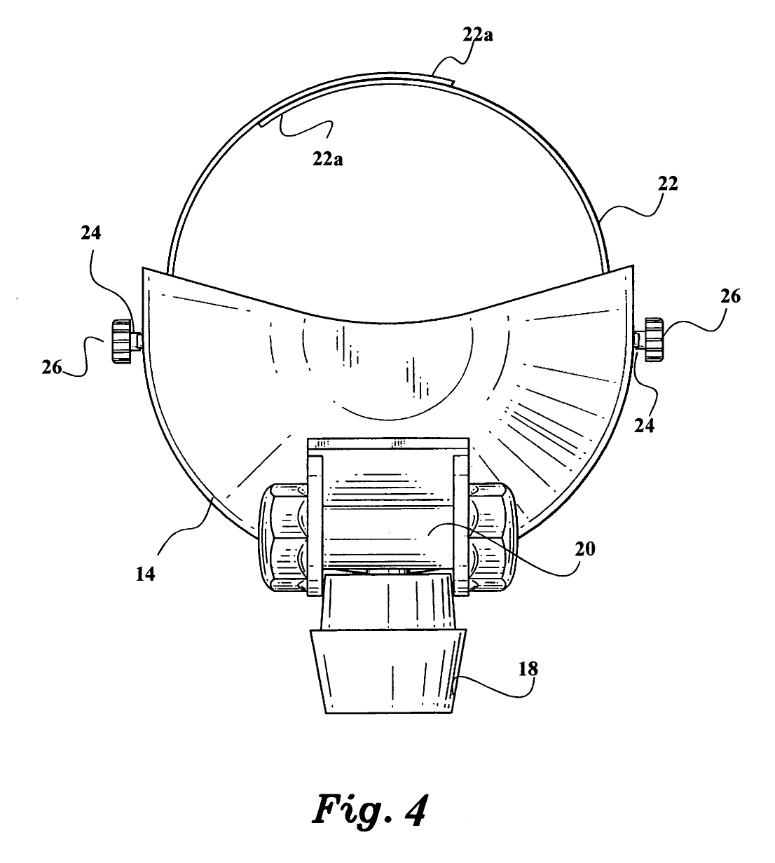

Attention is directed to FIGS. 1-4 of the drawings wherein the present invention is generally indicated at 10. The invention is simplistic in design and comprises a face and eye shield 12 mounted to a partial helmet member 14. Shield 12 has a curved configuration and is fabricated from flexible, transparent, polyester material. To assure adequate coverage, it has been determined that the shield should have a length of approximately 15.5 inches and a circumferential surface width of approximately 7.5 inches. Partial helmet member 14 is adapted to cover the front portion of a wearer's head. Member 14 is fabricated from a hard rigid material (plastic, metal, etc.) and has a curved outer surface 16. Shield 12 is mounted to the outer surface 16 in a suitable manner. A battery-operated lamp 18 is secured to helmet member 14 at a forward area thereof. Lamp 18 is mounted on axle 20 for limited pivoted movement. A headband 22 is fabricated from strong flexible material (leather, plastic, padded metal, etc.) and is provided with free ends 22a. Ends 22a may be secured in any suitable manner (buckles, hook and loop, pegs, etc.) to afford easy adjustability. However, the means of adjusting and securing must be sturdy enough to support the shield and helmet without slipping. Shield 14 is pivotally secured to headband 22 at diametrically opposed pivot axis 24. Knobs 26 are provided to adjust the tightness of the shield on pivot axis 24.

In use, the wearer simply dons the device and adjusts the headband to attain a comfortable, secure fit. When pivoted downward, the shield is of a size to cover the entire facial area, thus affording a maximum degree of protection. The lamp may be controlled with a conventional on/off switch (not shown). When desired, the shield is pivoted upward to uncover the face without the need to remove the entire device from the wearer's head.

It is to be understood that the present invention is not limited to the embodiment described above, but encompasses any and all embodiments within the scope of the following claims.

1. A protective device adapted to be worn on the head of a user comprising:
a helmet member, said helmet member having a curved outer surface;
a transparent face shield, said face shield having a curved configuration and mounted to said curved outer surface of said helmet member; and
a flexible headband, said headband adapted to fit around the head of a user, wherein said transparent face shield is pivotally attached to said flexible headband.

2. A protective device as recited in claim 1, wherein said helmet member has a top surface and including a battery-operated lamp attached to said helmet on said top surface.

3. A protective device as recited in claim 2, wherein said lamp is mounted on an axle for limited pivoted movement thereon.

4. A protective device as recited in claim 1, wherein said headband is provided with free ends.

5. A protective device as recited in claim 1, wherein said helmet is fabricated from a durable rigid material.

6. A protective device as recited in claim 1, wherein said transparent face shield is pivotally attached at two points on said headband.

7. A protective device adapted to be worn on the head of a user comprising:
a helmet member, said helmet member having a curved outer surface;
a transparent face shield, said face shield having a curved surface and a length, said transparent face shield being mounted to said curved outer surface of said helmet member; and
a flexible headband, said headband adapted to fit around the head of a user, wherein said transparent face shield is pivotally attached at two points to said flexible headband.

8. A protective device as recited in claim 7, wherein said length of said face shield is approximately 15.5 inches.

9. A protective device as recited in claim 7, wherein said curved surface of said face shield has a width and said width is approximately 7.5 inches.

10. A protective device adapted to be worn on the head of a user comprising:
a helmet member, said helmet member having a curved outer surface;
a transparent face shield, said face shield having a curved surface, said curved surface having a width of approximately 7.5 inches and a length of approximately 15.5 inches, said transparent face shield being mounted to said curved outer surface of said helmet member; and
a flexible headband, said headband adapted to fit around the head of a user, wherein said transparent face shield is pivotally attached at two points to said flexible headband.

11. A protective device as recited in claim 10, wherein said helmet member has a top surface and including a battery-operated lamp attached to said helmet on said top surface.

12. A protective device as recited in claim 11, wherein said lamp is mounted on an axle for limited pivoted movement thereon.

13. A protective device as recited in claim 10, wherein said headband is provided with free ends.

14. A protective device as recited in claim 10, wherein said helmet is fabricated from a durable rigid material.
